(19) United States
(12) Patent Application Publication
(10) Pub. No.: US 2006/0203363 A1
(43) Pub. Date: Sep. 14, 2006

(54) Three-dimensional image display system

(76) Inventor: Patrick Levy-Rosenthal, Paris (FR)

Correspondence Address: OLIFF & BERRIDGE, PLC, P.O. BOX 19928, ALEXANDRIA, VA, 22320, US

(21) Appl. No.: 10/567,542

(22) PCT Filed: Aug. 4, 2004
(86) PCT No.: PCT/FR04/02082

§ 371 Date: Feb. 8, 2006

(30) Foreign Application Priority Data
Aug. 8, 2003 (FR) 0309756

(51) Int. Cl. G02B 5/10

(52) U.S. Cl. 359/858

(57) ABSTRACT

The invention relates to a system which reproduces images in tree dimensions, comprising:
a mobile screen (10) which receives and reproduces the images
an optical device (20, 22) for producing an image (18) from the screen in space, and
synchronising means (32) that synchronise the nature of the produced images and the position of the screen with the spatial position of the viewer (12) relative to the system such that, on the one hand, the image always remains in the field of vision of the viewer and, on the other hand, that the angle of view of the image obtained on the screen corresponds to the position of the viewer, in particular, that of the viewer's face.

The invention relates to a system for reproducing three-dimensional images so that a scene can be watched from different angles.

It exist different systems for reproducing three-dimensional images: hologram systems, systems requiring to wear spectacles, Fresnel lens systems, etc.

The present invention is due to the observation that said systems known in the art do not allow an effortless view on the scene, which can be seen from different angles and along different axes. “Scene” as used herein refers to an element, i.e. one or more objects, one or more persons, one or more animals, plants, landscapes, etc.

The invention provides a three-dimensional image generation system which fulfils this function.

Thus, the system according to the invention contains:
a mobile screen which receives and reproduces images,
a mean for producing an image from the screen and for providing a 3D impression, and
synchronising means for adjusting the position of the screen and of the reproduced images depending on the spatial position of the viewer relative to the system.

Under these conditions, if the images appearing on the screen are provided by computer systems containing or receiving images of scenes from different angles of view, the synchronising means provide the images corresponding to the viewer's position and assure a certain displacement of the screen so that the viewer can always see the image.

In one realisation, the images taken from different angles of view can be retrieved from a memory.

In another realisation, the images appearing on the screen are provided by devices which capture the images of the scene from different angles depending on the viewer's position.

The synchronising means are for example such that the angle of view of the reproduced image varies in proportion of the viewer's displacement. In one realisation, the angle of view of the reproduced image varies in a higher manner than the displacement of the viewer in order to minimise the displacement of the viewer relative to the system.

In one realisation, the system comprises picture-taking devices, such as at least one camera, for observing in real time the viewer's spatial position. The viewer's position is determined by the position of a part of the viewer's body, preferably at least one of the following parts: the eyes, the nose, the hands, the feet.

For detecting a part of the body, it is for example possible to use software products such as those distributed by the Australian society Seeing Machine.

According to one realisation, the system comprises, on the one hand, detection means for detecting a part of the face such as the eyes or the nose, and, on the other hand, detection means for detecting another part of the viewer's body, in particular, his hand, or even both of his hands. In this case, the detection means for detecting the viewer's hand (or another part of the body) detect the presence of the hand in the region where the viewer sees the three-dimensional image and the system comprises means for producing an interaction of said means of detection of the hand and of means of image generation or selection. Thus, a pressure executed by the hand in the region where an object which in reality is soft, provokes deformation of said object, or a gesture provokes displacement of the object. Generally, the interaction of the hand, or another part of the body, and the scene, can modify other parameters of the virtual scene, for example its colour or its texture.

Thus, the interaction between the viewer and the virtual scene seen three-dimensionally (i.e. the synchronisation of the nature of the produced images and of the screen position with the viewer's spatial position relative to the system) is achieved in two ways:

According to the first way; the viewer's displacement, in particular his face, provokes the reproduction of a different angle of view of the virtual scene. For example, if the viewer first sits and then stands up, he passes from the front view of an object into the top view of said object. According to the second way, a gesture of the hand provokes modification or displacement of a virtual object. The applications of the system according to the invention are numerous. To list some possible applications without limiting the scope thereof: television, videos, cinematographic films and information technology. In particular, the invention can be used for the presentation of virtual objects, especially for selling, in a shop or by diffusion, i.e. by the Internet.

The invention can also be applied for video conferences. Thus, in a realisation of the system which is applied in video conferences, a system of the above-defined type is provided for at least one of the interlocutors, and said system, which is in the first place, comprises means of delivering a signal to indicate the viewer's position as well as means for transmitting said signal which indicates the viewer's position to the picture-taking devices which are in the second place, where the second viewer can be found, these devices delivering the angle desired by the position (that means, by the position of the eyes) of the viewer in the first place. For example, a camera of the second interlocutor (in the second place), displaces for providing, in the first place, an angle of view of the second interlocutor which corresponds to the angle desired by the first interlocutor.

As a variation, the camera comprises, to prevent displacement of an emission camera, in one place two cameras taking pictures of the interlocutor which send simultaneously their images in two different angles to the three-dimensional vision system in the other place, and, in said other place, the system comprises means for reproducing the 3D image of the second interlocutor. In this realisation, the quantity of the transmitted information is two times higher between the two interlocutors than in the first realisation of video conference systems.

Whatever may be the application in the system according to the invention, the three-dimensional effect can be obtained in different ways.

According to one realisation, an optical device is associated to the screen, such as a mirror or a group of mirrors, which reflects the image from the screen to the spatial position where the viewer's eyes are directed to.

In this case, the system comprises, for example, means for modifying separately the position of the screen and the position of the optical device.

In a variation, the screen and the optical device are attached to a casing or a chassis and have a fixed position relative to said casing or chassis which has command means for moving it, for example, in two orthogonal axes. When the optical device has at least one mirror, this mirror has, for example, a spherical or parabolic form.

Thus, the invention relates to a system for reproducing three-dimensional images comprising:
a mobile screen which receives and reproduces images,
an optical device for producing an image of the screen in space, and
synchronising means for synchronising the nature of the produced images and of the position of the screen with the viewer's spatial position to the system for obtaining, on the one hand, that the image remains permanently in the field of vision of the viewer and, on the other hand, that the angle of view of the image obtained on the screen corresponds to the position of the viewer, in particular, that of the viewer's face.

In one realisation, the system comprises a memory in which are stored a plurality of images of a same scene in a plurality of angles of view, the synchronising means reproducing the image which corresponds to the angle of view associated to the viewer's position.

In a variation, the system comprises command devices which take pictures of a scene, which make it possible, with the help of the synchronising means, to take the image from an angle of view which corresponds to the viewer's position.

In this case, the cameras can be displaceable depending on the viewer's position.

In a variation, there are at least two cameras or analogues for providing two angles of view of a same scene, the synchronising means comprising processing means which reproduce from the two angles of view the angle of view which corresponds to the viewer's position.

The system constitutes, in one realisation, a system which can be used for video conferences, and comprises a picture-taking device for reproducing for a distant interlocutor the image of the interlocutor using the system.

In one realisation, synchronising means comprise, on the one hand, detection means for detecting of the position of the viewer's face, or of a part of the face, in particular the eyes, and, on the other hand, detection means for detecting another part of the viewer's body such as the hand or the feet, as well as processing means so that the apparition or the displacement of this other part of the body provokes a modification of the obtained three-dimensional image, this modification being, for example, displacement deformation or modification of texture or colour.

The optical device has, for example, a fixed position.

In a variation, the system comprises a chassis, which is attached to, at the one hand, the screen, and, at the other hand, the optical device, wherein the screen and the optical device are attached to this chassis and the synchronising mean comprise means for modifying the position of the chassis.

Preferably, the optical device comprises at least one spherical or parabolic mirror.

Further properties and advantages of the invention will appear within the description of some of its realisation modes, the description being effected by referring to the figures attached below among which:

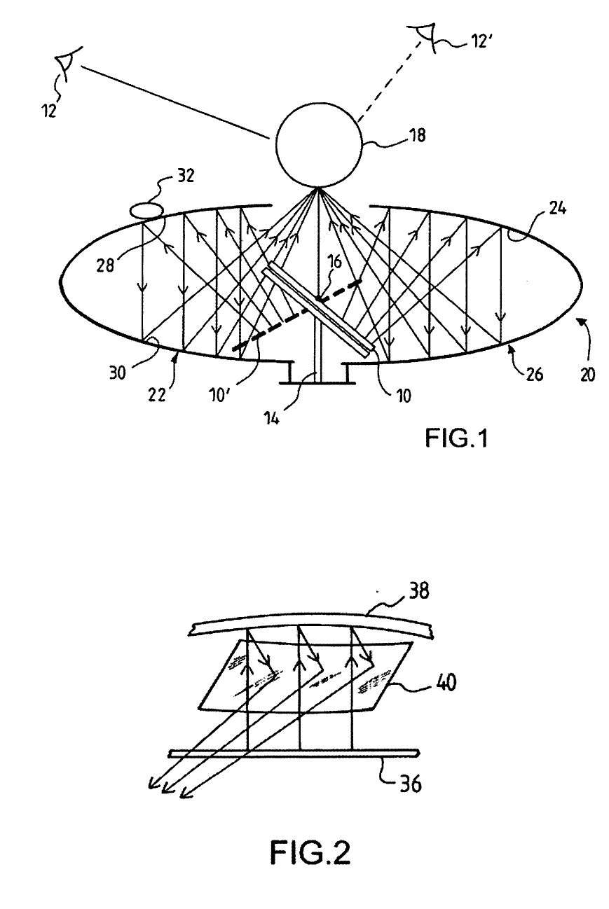

FIG. 1 is a scheme of a realisation mode of a system according to the invention,

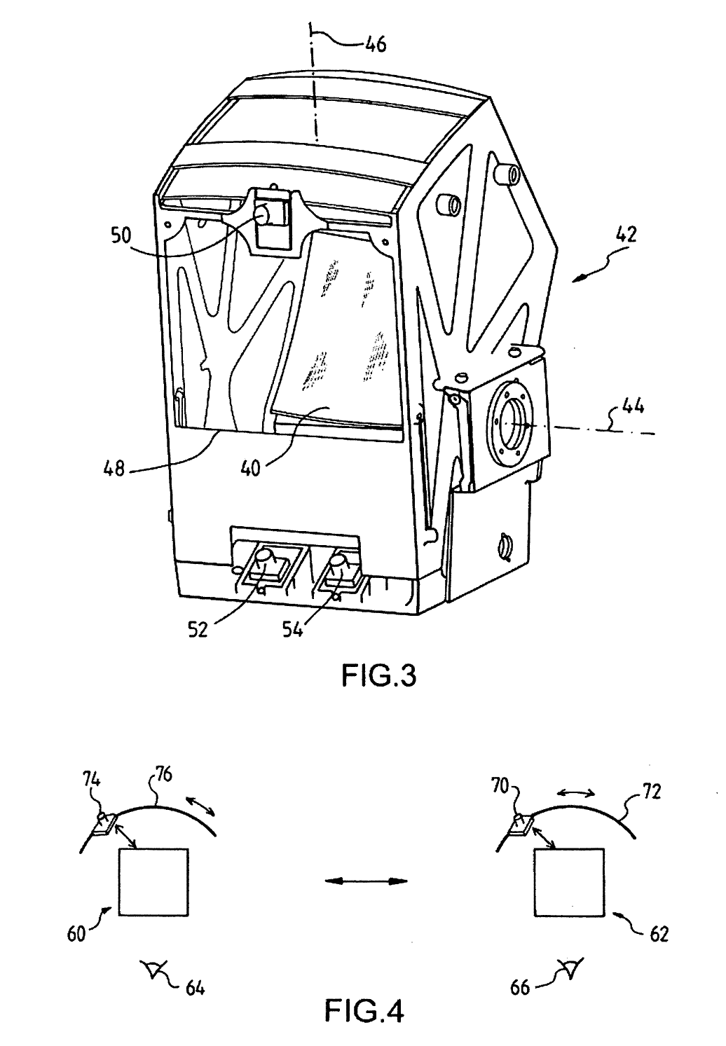

FIGS. 2 and 3 are schemes of another realisation of a system according to the invention, and

FIG. 4 is a scheme of the use of a system according to the invention.

In the example illustrated in FIG. 1, the system according to the invention comprises a screen 10 which receives images from a computer (not shown) or even on line from a television system such as the system of a video conference. The screen can be, for example, a liquid crystal, plasma or cathode ray tube screen.

To the screen are associated image generating means which furnish views of a scene depending on the viewer's position, particularly of his face and most particularly of his eyes 12. The screen 10 is attached to a vertical support 14 to which is associated a command mean to make this support move around its axis. Furthermore, the screen 10 can move around a horizontal axis because of a joint or a support 14 due to second command means. Said first and second command means adjust the position of the screen 10 depending on the position of the viewer 12 so that the virtual image in three dimensions, 18, seen by the viewer 12, remains permanently in his field of vision.

The system comprises an optical device which contains, in the example, two parabolic mirrors 20 and 22. When the viewer is standing in the position 12 which can be seen in FIG. 1 and when the screen is in the position 10 in continuous, the image on the screen is reflected on the upper part 24 of the parabolic mirror 20, after that, it is reflected on the lower part 26 of the same mirror 20 for focalising at the place 18. When the viewer displaces from position 12 to position 12′, the screen takes the position 10′ which is in broken line on FIG. 1. The image it produces is reflected by the upper part 28 of the parabolic mirror 22, then it is reflected by the lower part 30 of said mirror 22, and from there, it is focalised to the same place 18.

The viewer's position is detected by a device comprising a camera 32 as well as means of recognition of the viewer's body, such as a part of his face, in particular the eyes.

The 3D-effect is due to the fact that the screen image is focalised in one spatial point and, thus the viewer does not have the impression of observing a screen but to see an object floating in the air. Additionally, the 3D-effect is amplified by the image synchronisation when the viewer displaces.

In another realisation, which can be seen in FIGS. 2 and 3, a screen 36 and an optical device with two retransmission mirrors 38 and 40 are provided and this combination of the screen and the mirrors 38 and 40 are attached to a casing or chassis 42 which is associated to command means which make said chassis move around a horizontal axis and a vertical axis 46.

The screen 36 and the mirrors 38 and 40 have a fixed position depending on the chassis 42. Thus, as it can be seen in FIG. 3, the casing 42 comprises a wide frontal opening 48 opposite the mirror 40. And the virtual image is formed before this frontal opening 48.

The frontal part of the system comprises, in its upper part, a camera 50 for detecting the position of a part of the viewer's face, such as the eyes or the nose for example. Additionally, in the lower part are provided two cameras 52 and 54 for detecting the position of the viewer's hands when they approach opening 48, i.e. when they approach the place where the virtual object is focalised.

In a variation, the camera 50 is used for detecting simultaneously the position of one part of the face and the position of the hands.

Of course, depending on the desired interaction between the virtual object and the viewer, the cameras and the associated processing means can be arranged to detect other parts of the body. For example, in a variation, the cameras 52 and 54 (or the camera 50) are arranged to detect the viewer's feet in the case of a game by means of a virtual ball.

FIG. 4 is a scheme for a video conference system which provides 3D images and comprises, for every interlocutor, a system 60, 62 of the same time as it can be seen in FIG. 1 or in FIGS. 2 and 3.

Every system 60, 62 contains the different components described above concerning FIGS. 1, 2 and 3, i.e. a camera (not shown in FIG. 4) for detecting the position of the face, in particular the eyes, of the viewer.

In this system, the provided images are in particular the faces of the interlocutors. In other words, the image which is furnished to the viewer 64 of system 60 is the image of the face of viewer 66 of system 62.

For obtaining that the angle in which is seen viewer 66 by viewer 64 corresponds to the desired angle, which is determined by the position of the eyes of viewer 64, a camera 70 is associated to the system 62 as well as means for displacing said camera according to a trajectory 72 so that this cameras takes the image of viewer 66 in the angle desired by viewer 64.

In the same way, to system 60 is associated a camera 74 which displaces following a trajectory 76, this camera 74 furnishing to the viewer 66 a view of the interlocutor 64 in the angle desired by the viewer 66, i.e. according to the position of the eyes of interlocutor 66 in the example.

In a variation, two cameras (not shown in the figure) are associated to both systems 60, 62 which furnish two different angles of view of the viewer and said angles of view are transmitted to the system of the other interlocutor. In this case, the system comprises processing means for furnishing, from the two received views, a view which corresponds to the angle desired by the viewer at the other end.

Of course, the invention is not limited to the realisation mode specifically described herein. It also includes its variations. In particular, picture-taking devices other than a camera can be used. Thus, in case of the system being holographic, a laser system should be used for taking the image.

1. System for reproducing three-dimensional images, comprising:
a mobile screen (10; 36) that receives and reproduces images,
an optical device (20, 22; 38, 40) for producing an image (18) from the screen in space, and
synchronising means (32) that synchronise the nature of the produced images and the position of the screen with the spatial position of the viewer (12) relative to the system such that, on the one hand, the image always remains in the field of vision of the viewer, and, on the other hand, that the angle of view obtained on the screen corresponds to the position of the viewer, in particular, that of the viewer's face.

2. System according to claim 1 comprising devices for modifying the angle of view of the image that is to be reproduced depending on the viewer's displacement.

3. System according to claim 1, wherein the system comprises devices for detecting the viewer's spatial position in real time.

4. System according to claim 1 comprising a memory wherein a plurality of images of a same scene is stored in a plurality of angles of view, the synchronising means herein reproducing the image corresponding to the angle of view associated to the viewer's position.

5. System according to claim 1 comprising command devices taking pictures of a scene, by synchronising means, for taking the image of the scene in a viewer's angle which corresponds to the viewer's position.

6. System according to claim 5 wherein the picture-taking devices (70, 74) can be displaced depending on the viewer's position.

7. System according to claim 5 wherein the picture-taking devices are at least two cameras or analogues for taking two viewer's angles of the same scene, the synchronising means herein comprising processing means for reproducing the angle of view corresponding to the viewer's position form the two angles of view.

8. System according to claim 1 constituting a system that can be used for video conferences, wherein said systems contain a picture-taking device for reproducing, for a distant interlocutor, the image of the interlocutor who uses the system.

9. System according to claim 1, wherein the synchronising means comprise, on the one hand, means for detecting the position of the viewer's face or of a part of it, in particular, the eyes, and, at the other hand, for detecting another part of the viewer's body such as the hands or the feet, and processing means so that the apparition or the displacement of said other part of the body modifies the image obtained in three dimensions, this modification being for being for example a displacement, a deformation or changing of colour or texture.

10. System according to claim 1, wherein the optical device (20, 22) has a fixed position.

11. System according to claim 1 comprising a chassis (42) to which is attached, at one hand, the screen (36) and, at the other hand, the optical device (38, 40), wherein the screen and the optical device are attached to said chassis, the synchronising means comprising means for modifying the position of the chassis.

12. System according to claim 1 wherein the optical device comprises at least one spherical or parabolic mirror.
